(19) United States
(12) Patent Application Publication
(10) Pub. No.: US 2023/0265871 A1
(43) Pub. Date: Aug. 24, 2023

(54) DETECTION OF AN ANOMALY IN A FLUID POWER SYSTEM

(71) Applicant: SICK AG, Waldkirch (DE)

(72) Inventors: Raphael GAEDE, Waldkirch (DE); Thomas WEBER, Waldkirch (DE); Dennis SONNTAG, Waldkirch (DE)

(21) Appl. No.: 18/110,992

(22) Filed: Feb. 17, 2023

(30) Foreign Application Priority Data
Feb. 18, 2022 (EP) 22157382.7

(51) Int. Cl. F15B 19/00; G01M 3/26

(52) U.S. Cl. CPC F15B 19/005; G01M 3/26

(57) ABSTRACT

A sensor device (18, 20) for detecting an anomaly in a fluid power system (10) is specified, which has at least one sensor (18) for determining a measured value for the instantaneous flow velocity in a line (14) of the system (10), and a control and evaluation unit (20) that is designed to determine, on the basis of at least one measured value, whether an anomaly is present. The control and evaluation unit (20) is furthermore designed to evaluate a time series of measured values in order to initially determine a period duration, to determine at least one characteristic variable for at least one section of the time series of the period duration, to compare the characteristic variable to a reference characteristic variable and, in the event of deviation by more than a tolerance, to determine the presence of an anomaly.

The invention relates to a sensor device and to a method for detecting an anomaly in a fluid power system.

The generation and treatment of compressed air makes a considerable contribution to industrial electricity demands. Compressed air is an energy source that is important and expensive at the same time. It is therefore important to detect anomalies in a compressed air system as soon as possible in order to effectively cap energy consumption and operating costs. DIN EN ISO 11011:2015-08 provides a basis for the procedure and documentation for evaluating the energy efficiency of compressed air systems.

Various approaches are therefore being taken in the prior art to check compressed air systems for anomalies and, in particular, leaks. As compressed air escapes a closed system, the pressure inside drops. It is therefore possible, as described, for example, in DIN EN 13184:2001-07, to pressurize a closed pneumatic system of known volume and, after reaching a thermal equilibrium state, to measure the pressure drop over a certain period of time. Via a change compared to an expected pressure drop, leaks are determined with high sensitivity but not localized. In the process, the compressed air system must be taken out of operation for several hours, and only branches of the system that are also under pressure in the static state can be checked. Anomalies other than leaks are not recorded.

DE 20 2019 210 600 B4 discloses a diagnostic device that monitors a valve arrangement provided for the pressure control of a pressure chamber. The pressure control ensures that a pressure setpoint is reached or maintained. A pressure fluid leak is concluded from the pressure control actuating signal. The diagnosis is thus attached to the pressure control, so to speak. This does not describe how the pressure control obtains the required pressure control actuating signal, and in any case does not overcome the disadvantages of pressure-based recording of anomalies.

Another approach, which also localizes leaks in compressed air systems, is based on the measurement of ultrasound generated by the escape of gases. This requires special measurement techniques that detect such ultrasound and make it audible to the human ear. Like pressure change methods, such ultrasonic measurements are costly and time-consuming. From an economic point of view, professional leak localization using ultrasonic technology only makes sense if it is already known in advance that there are leaks in the system. Ultrasound also fails to record anomalies other than leaks.

Flow measurement sensors that have integrated leak detection are now offered. Such monitoring takes place in phases of standstill, which is assumed when the measured mass flow falls below a first threshold value, wherein a leak is detected if a mass flow is still recorded at standstill, which is checked with a second threshold value. It is extremely tricky to set the threshold values correctly in order to, on the one hand, still be able to detect the standstill at all in the event of a major leak and, on the other hand, to not confuse a low mass flow in control operation with a leak. In addition, leaks are only detected in components that are pressurized with compressed air during standstill, whereas it is common practice to depressurize a large part of the system during standstill, which is then not taken into account in the detection of leaks.

In the prior art, artificial intelligence methods are also used to evaluate sensor data in order to uncover anomalies in a compressed air system. For example, a neural network learns the relationship between control signals of compressed air actuators and the associated mass flow rate from known data in order to then predict the flow rate to be expected for future process operations after training is complete. If the discrepancy between measured and predicted mass flow rate is too large, a leak is concluded. This works quite well in a particular concrete compressed air system, but generalization to any system is difficult and individual training for the single system is usually too costly. In addition, the exten-sive technical infrastructure with sufficient computing power and working memory is often lacking on site because the sensors themselves typically do not have the hardware that inferences or even the training of neural networks would require.

Approaches to the detection of leaks in compressed air systems using artificial intelligence methods can be found, for example, in the work of San-tolamazza, A., V. Cesarotti, and V. Introna, “Evaluation of machine learning techniques to enact energy consumption control of compressed air generation in production plants,” 23rd Summer School “Francesco Turco”-Industrial Systems Engineering 2018, vol. 2018, AIDI-Italian Association of Industrial Operations Pro-fessors, 2018 and by Desmet, Antoine and Matthew Delore, “Leak detection in compressed air systems using unsupervised anomaly detection techniques,” Annual Conference of the PHM Society, vol. 9, no. 1, 2017.

In DE 10 2020 100 347 A1, flow anomalies in a cleaning system are detected by recording sounds caused by the conduction of liquids with microphones and superimposing this sound information with an image of the cleaning system. If noises arise in unexpected places, this is attributed to a leak.

It is therefore an object of the invention to improve the detection of anomalies in a fluid power system.

This object is satisfied by a sensor device for detecting an anomaly in a fluid power system, comprising at least one sensor for determining a measured value for the instantaneous flow velocity in a line of the system, and a control and evaluation unit configured to determine, on the basis of at least one measured value, whether an anomaly is present, wherein the control and evaluation unit is further configured to evaluate a time series of measured values in order to initially determine a period duration, to determine at least one characteristic variable for at least one section of the time series of the period duration, to compare the characteristic variable to a reference characteristic variable and, in the event of deviation by more than a tolerance, to determine the presence of an anomaly.

The object is also satisfied by a method for detecting an anomaly in a fluid power system, wherein at least one sensor determines a respective measured value for the instantaneous flow velocity in a line of the system and it is determined, on the basis of at least one measured value, whether an anomaly is present, wherein a time series of measured values is evaluated in order to initially determine a period duration, at least one characteristic variable is determined for at least one section of the time series of the period duration, the characteristic variable is compared to a reference characteristic variable and, in the event of deviation by more than one tolerance, the presence of an anomaly is determined.

Fluid power refers to the various methods of transmitting energy by means of fluids, in particular pneumatic or compressed air systems, wherein any gas can be used, and even hydraulic systems with a hydraulic fluid instead of air. Anomalies include leaks but also other undesirable conditions of the monitored system, such as clogged filters, kinked hoses and the like.

At least one sensor determines a measured value for the instantaneous flow velocity in a line of the system. Depending on the sensor principle, the actual measured value can differ from a flow velocity but can be converted into a flow velocity if the latter is not already measured directly. A control and evaluation unit uses at least one such measured value to determine whether an anomaly exists in the system. The control and evaluation unit can be part of or connected to the sensor, for example as a programmable logic controller, edge device, cloud or other computing device, or can be implemented in a distributed manner across the sensors and connected devices.

The invention starts from the basic idea of collecting a time series of measured values and comparing them to an expectation when the system is intact without anomalies. The time series preferably forms an immediate history of all the most recent measured values, ending with the respective current measured value, but thinned-out time series and/or the inclusion of at least somewhat less recent measured values is also conceivable. Initially, a period duration is determined from the time series because it is assumed that the system is used cycli-cally during operation because processing and production cycles repeat in practice.

A single period or a plurality of such periods are then evaluated by consid-ering one section of the period duration from the time series or a plurality of such sections. For this purpose, one or more characteristic variables are determined, which in particular reflect statistical characteristics of the respective period. This at least one characteristic variable is compared to a respective associated reference characteristic variable, i.e., an expectation of the characteristic variable when the system is intact without anomalies. If this does not match within a tolerance, an anomaly is assumed. The tolerance is preferably determined individually per characteristic variable, as described below in various embodiments, but can alternatively also be specified as an absolute or relative deviation. A detected anomaly is preferably reported, for example as a signal to a higher-level system controller, a separate display, a warning and/or a maintenance request.

The invention has the advantage of reliably detecting anomalies through-out the entire system. Even small leaks that are only effective for a short period of time are recorded. With conventional evaluations with threshold values, this often remains undetected because a global variable, such as an average or max-imum mass flow rate, is hardly affected. In addition to leaks, other anomalies that also affect the energy efficiency and functionality of the system but are not recorded in the prior art are also recorded. Such anomalies could also affect the quality of the final product so that the invention additionally contributes to quality assurance. Owing to the independent determination of the periodicity, no information regarding the manufacturing process supported by the system needs to be communicated so that a deeper integration of the sensor into a system controller is not necessary. By not using artificial intelligence methods, the hardware requirements also remain very low.

The control and evaluation unit is preferably designed to determine a statistical characteristic variable of the distribution of flow velocities over the period duration. A statistical characteristic variable has the advantage that small transient deviations due to measurement inaccuracies and the like have only a minor effect on it. By statistically evaluating the distribution of the flow velocities in particular, an even higher robustness is achieved because different time sequences also do not matter in this respect. An analysis of the frequency of occurrence of the measured values within a period decouples the measured values from time. This also means that no time stamps of the measured values are required. As in all embodiments, the reference characteristic variable is to be selected appropriately, thus in this case also a statistical characteristic variable of the distribution of flow velocities of the intact system. Likewise, as in all embodiments, exactly one period or a plurality of periods can be evaluated.

The control and evaluation unit is preferably designed to form a histogram of the flow velocities over the period duration, wherein at least one characteristic variable is determined from the count in one bin of the histogram. The histogram is a discretization of the distribution of the measured flow velocities and thus particularly easy to handle. The count in one of the bins of the histogram can be used as a characteristic variable, preferably a plurality of such characteristic variables is determined for a plurality of or all bins. Once again, the reference characteristic variable is preferably determined analogously, namely from a histogram recorded with the system intact and without anomalies.

The control and evaluation unit is preferably designed to determine the cumulative difference between the measured values of the time series and a reference time series. This evaluation can also take place over exactly one period or over a plurality of periods. The reference time series corresponds to measured values of the intact system without anomalies. In this embodiment, each measured value is itself a characteristic variable, so to speak, while the reference time series provides the associated reference characteristic variables. By reducing the resolution of the time series as described later, the number of characteristic variables can be reduced. The differences determined point-by-point between the time series of measured values and the reference time series may also be understood as the difference area between a measured curve and a reference measured curve over one period or over a plurality of averaged periods. Mathematically, it corresponds to the integral of the magnitude of the difference between the measured curve and the reference measured curve.

The control and evaluation unit is preferably designed to record and evaluate the time series of measured values during operation of the system. Anomaly detection therefore takes place online or during normal operation, and it is not necessary to shut down or pause the system. This differs from many of the prior-art methods described in the introduction, in which anomalies can only be recorded when the system is at a standstill, or even a special state must be set for this purpose, for example with regard to the pressure in the system.

The control and evaluation unit is preferably designed to determine the period duration by calculating an autocorrelation, Fourier transform or magnitude differences in the time series. In the autocorrelation or in the corresponding spec-trum of the time series, peaks are shown according to periodicity. Such methods for determining the period duration of a time series are known per se but have not yet been used for the detection of anomalies in a fluid power system. A preferred embodiment of the determination of autocorrelation is the formation of cumulative magnitudes of the differences of the time series shifted against itself, iteratively increasing the interval of the shift. If the sum of the magnitude differences is now plotted over the shifts, extreme values in the period duration and its multiples are obtained. In the conventional methods as described in the introduction, the period duration would not be of interest.

The control and evaluation unit is preferably designed to detect and correct a mutual time offset of sections of the period duration. Although the individual work cycles in the system in principle have the period duration, there can always be minor time shifts. Such fluctuations or phase shifts between periods could distort the recording of anomalies, and it is therefore advantageous to compensate for the time offset. The sections to be evaluated are then aligned with one another in such a manner that the courses overlap as similarly as possible. This is achieved, for example, by calculating correlations in pairs of the sections.

The control and evaluation unit is preferably designed to convert the time series of measured values into a time series with lower temporal resolution. After such a reduction in resolution (“downsampling”), further evaluation can be carried out with less effort. In the simplest case, only every i-th measured value is simply retained, preferably followed by smoothing or low-pass filtering. Likewise, more complex interpolations with a time scaling factor that is then arbitrary are conceivable. Furthermore, it is conceivable to use the reduced resolution only for a part of the steps and to work with the full resolution for other steps. For example, the determination of the period duration and a correction of a mutual phase offset of sections of the period duration can take place with full resolution, but the characteristic variables are then determined after a resolution reduction.

The control and evaluation unit is preferably designed for a teach-in mode in which a time series of measured values is recorded and evaluated, a period duration is determined therefrom, at least one characteristic variable is determined for at least one section of the time series of the period duration and the characteristic variable is stored as a reference characteristic variable. The reference characteristic variables are thus obtained in teach-in mode, and this should therefore take place in a phase where it is ensured that there are no anomalies. Anomalies already present in teach-in mode will not be detected later but will be considered proper. The method used to determine the reference characteristic variables in principle corresponds to that used to determine characteristic variables during actual operation as described above. There is no need for comparison since teach-in is intended to record the situation as it is. Owing to the teach-in mode, flexible and easy-to-use adaptation to new systems and processes is possible.

In teach-in mode, a respective characteristic variable is preferably determined several times over different sections in order to determine a statistical measure as a reference characteristic variable and/or a fluctuation measure as a tolerance of the stored reference characteristic variable. By means of such a statistical teach-in under consideration of a plurality of periods, the appropriate tolerance can be taught-in in addition to a robust expectation. For example, a mean value, a focal point, a median, or another quantile is suitable as the statistical measure. The statistical measure can refer to intermediate results already obtained, such as the bins of a histogram. This determines an expectation. The fluctuation measure, for example the variance, standard deviation, a higher moment or combinations or multiples thereof, determines the associated tolerance for this expectation. The setting of fixed threshold values, as in some cases in the prior art, is no longer necessary.

In teach-in mode, a histogram of the flow velocities over the period duration is preferably formed, wherein the reference characteristic variable is determined from a count in a bin of the histogram and/or the associated tolerance is determined from a fluctuation measure of the count in a bin. A determination of characteristic variables and reference characteristic variables via histograms is particularly simple and at the same time leads to a highly reliable detection of anomalies. An expectation is established for individual bins, a plurality of bins or all bins and a check against it takes place during operation. The expectation corresponds to the statistical measure, such as a mean value, of the count in the respective bin, over the evaluation of a plurality of periods, while the tolerance is given by the fluctuation measure, for example, a multiple of the standard deviation of the counts determined in the bin over the different periods.

The control and evaluation unit is preferably designed to switch temporarily to teach-in mode when the period duration changes. In this embodiment, the sensor device independently detects if the observed process changes by a new period duration and thus a different processing or process cycle. This is then not understood as an anomaly but as a deliberate changeover, and the reference variables are appropriately taught in again. With the new reference variables, the sensor device can then monitor the modified process for anomalies. However, the new period duration should be stable; otherwise, this is preferably still regarded as an anomaly. The independent changeover can be combined with a warning and, if necessary, a confirmation that an intentional changeover has actually taken place can be requested.

The control and evaluation unit is preferably designed to switch between a plurality of sets with at least one reference variable. The sensor device is thus prepared for various processes of the system. By using the respectively appropriate set with at least one reference variable, preferably including an associated tolerance, anomalies are detected in the respectively active process.

The control and evaluation unit is preferably integrated in the sensor. The sensor device is then the sensor, or it is an intelligent sensor with integrated anomaly detection. No further technical infrastructure is then required to check the system for anomalies. Alternatively, the control and evaluation unit can be implemented in a manner distributed over a plurality of sensors, or there is at least one intelligent sensor with its own evaluation and at least one further connected sensor that only provides measured values, and any mixed forms.

The method according to the invention can be developed in a similar manner and shows similar advantages. Such advantageous features are described by way of example, but not exhaustively, in the subclaims following the independent claims.

The invention is explained in more detail below, also with respect to further features and advantages, by way of example with reference to embodiments and with reference to the attached drawing. The figures of the drawing show:

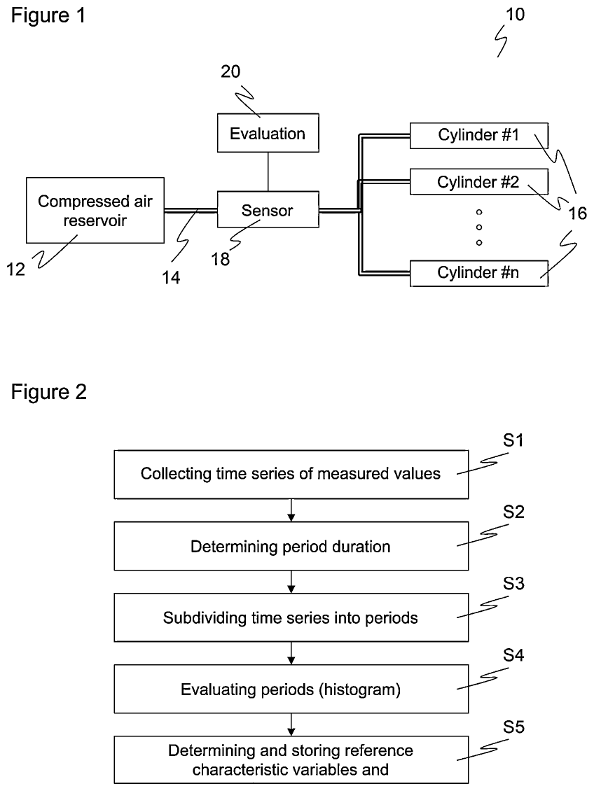

FIG. 1 a schematic illustration of a fluid power system with a sensor for its anomaly monitoring;

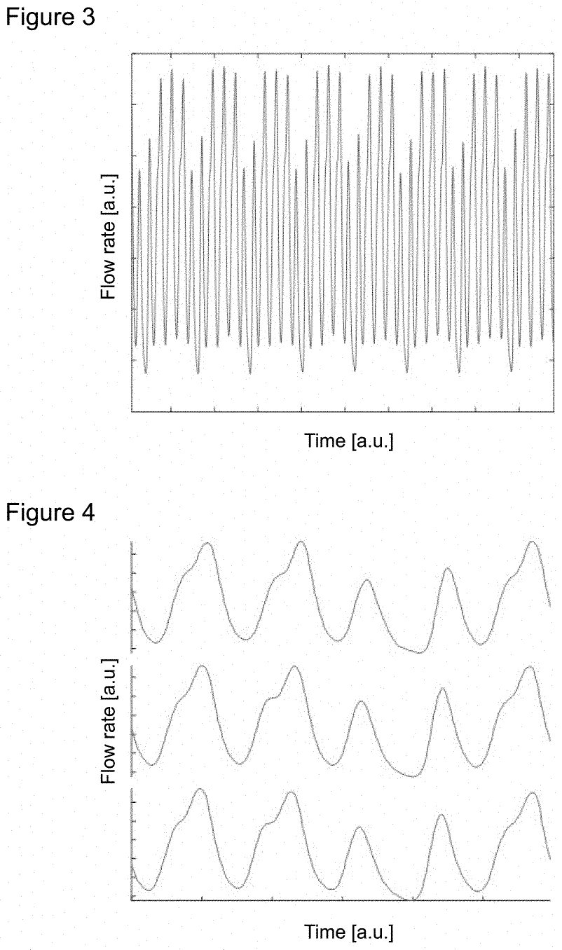

FIG. 2 an exemplary flow chart for teaching in an expectation of the system without anomalies;

FIG. 3 an illustration of an exemplary time series of measured values of the flow rate of the system without anomalies;

FIG. 4 an illustration of the time series according to FIG. 3, divided by periods;

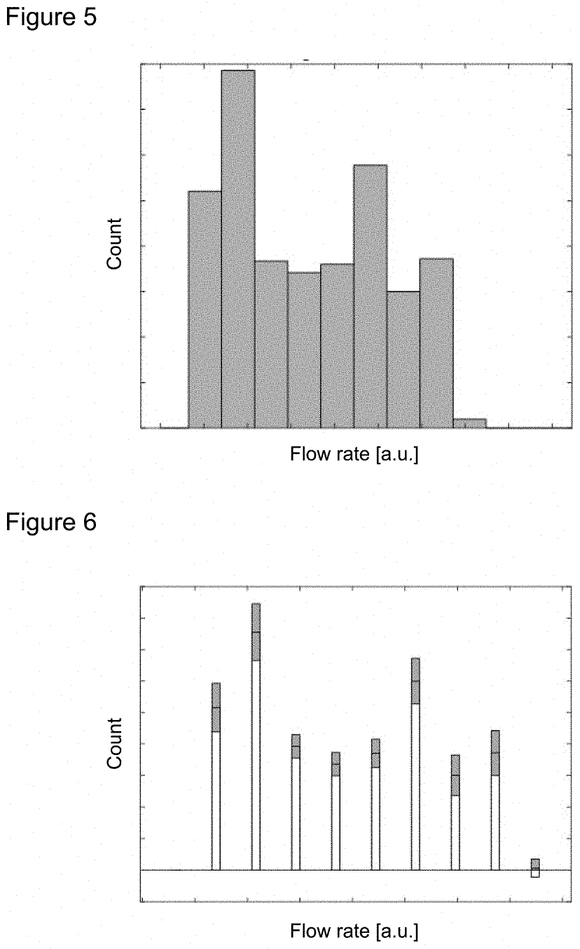

FIG. 5 a histogram of the frequencies of flow rates occurring over a respective period according to FIG. 4;

FIG. 6 an expectation, determined from a plurality of histograms over respective periods according to FIG. 5, of the count per bin with a tolerance range;

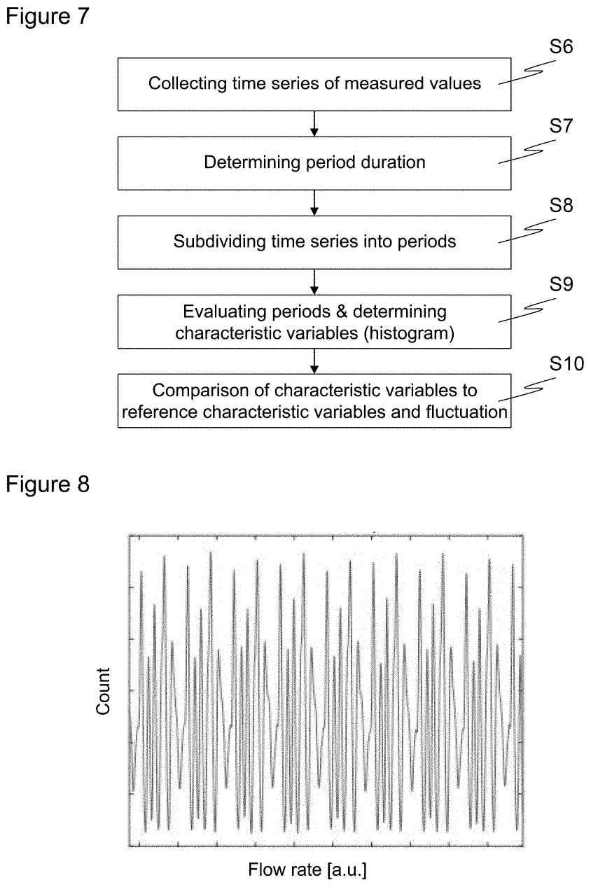

FIG. 7 an exemplary flow chart for checking the system for anomalies;

FIG. 8 an illustration of an exemplary time series of measured values of the flow rate of the monitored system;

FIG. 9 an illustration of the time series according to FIG. 8, divided by periods;

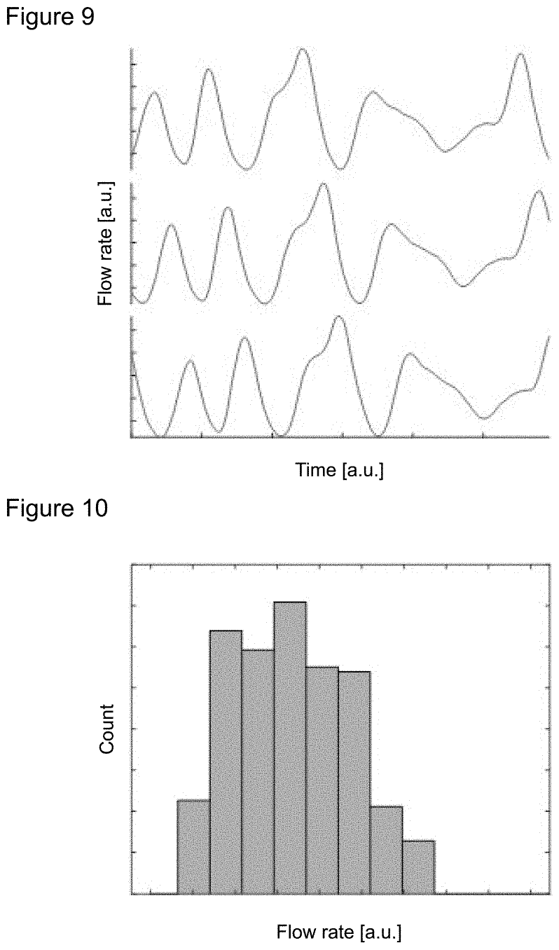

FIG. 10 a histogram of the frequencies of flow rates occurring over a respective period according to FIG. 9;

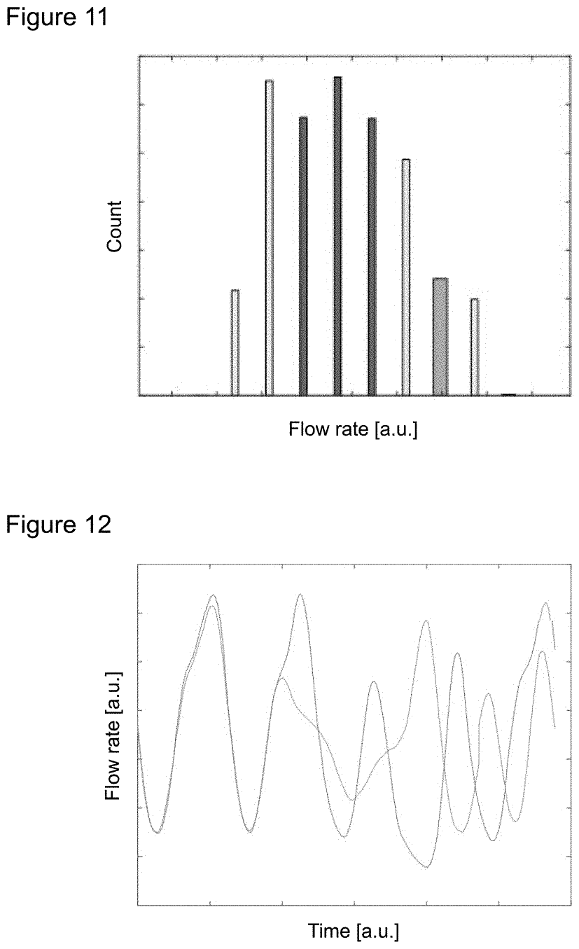

FIG. 11 the result of a comparison of the frequencies occurring in the histogram according to FIG. 10 to the expectations according to FIG. 6;

FIG. 12 a comparative illustration of two time series in a system with an anomaly and without an anomaly;

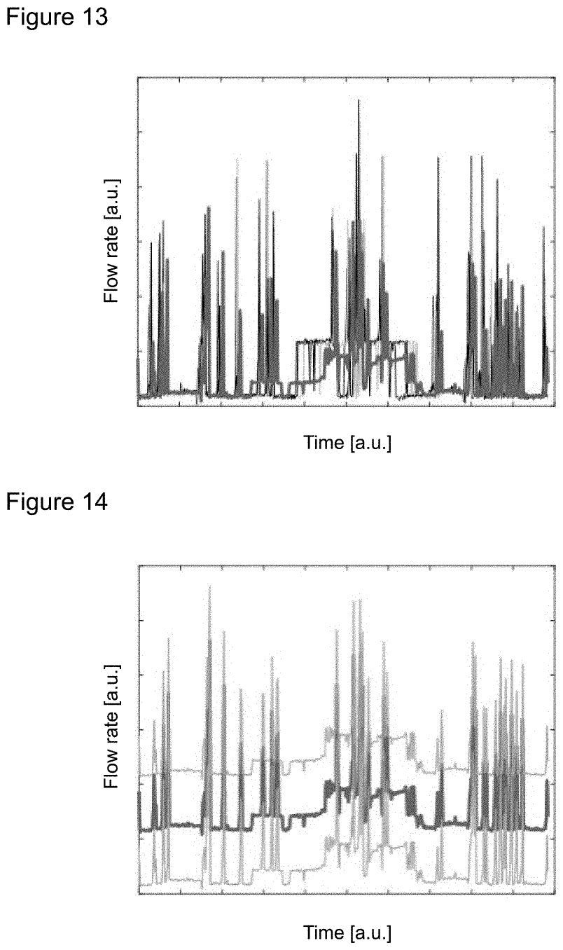

FIG. 13 a superimposed illustration of a plurality of time series of measured flow rates to illustrate the determination of a representative period;

FIG. 14 a separate illustration of the representative period determined according to FIG. 13 with a tolerance band; and

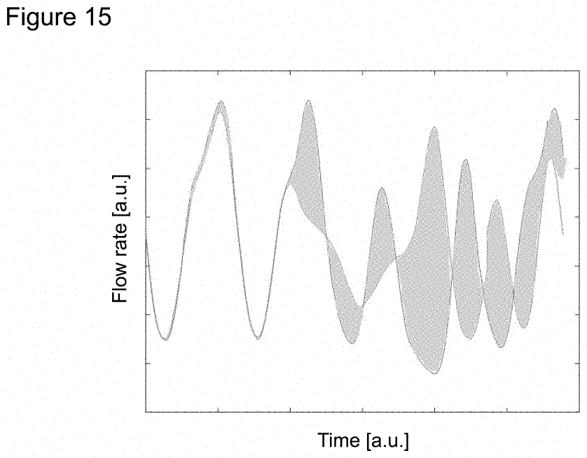

FIG. 15 an illustration of another evaluation for detecting anomalies by determining a difference area between a period of measured values in a system with an anomaly and without an anomaly.

FIG. 1 shows a schematic overview illustration of a fluid power system 10. In the example shown, it is designed as a compressed air system, but the invention also covers other fluid power systems, in particular also hydraulic systems in addition to pneumatic systems.

A compressed air reservoir 12 supplies various consumers with compressed air via lines 14; a plurality of working cylinders 16 is shown purely by way of example. A sensor 18, which measures the flow velocity of the compressed air, is arranged on the line 14. This measurement is typically used by the system controller (not shown) for general monitoring and control tasks of the system 10. According to the invention, the measurement data from the sensor 18 are used for anomaly monitoring, wherein this can be both the main and secondary purpose for attaching the sensor 18. In practice, the system can be much more branched and complex, and a plurality of sensors may be arranged at different points along the line 14 for the monitoring of anomalies.

The sensor 18 can realize any measuring principle for the flow measurement; in particular, it can be a Coriolis sensor, a magnetic-inductive flow sensor for a fluid other than air with a minimum conductivity, an ultrasonic flow sensor or a vortex sensor. It is also not necessary to measure the flow velocity directly, as long as the flow velocity or an equivalent measured variable, such as mass flow, can be derived from the measurement, such as in a pressure differential measurement. The sensor 18 is preferably installed as close as possible to the consumers or working cylinders 16 because then the effectively monitored volume remains small so that changes due to anomalies are recorded with a high degree of sensitivity.

Connected to the sensor 18, or integrated therein in deviation from the illustration, is a control and evaluation unit 20, in which the measurement data from the sensor 18 are evaluated to detect whether the system 10 is operating as expected or whether there is an anomaly there. In the event of a detected anomaly, the sensor 18 can indicate this or transmit a corresponding message to a higher-level controller (not shown) of the system 10. An anomaly is primarily a leak, but other anomalies, such as a clogged filter or a kinked line 14, are also possible. The method for detecting an anomaly is now explained with reference to the further figures.

FIG. 2 shows an exemplary flow chart for teaching in a reference or expectation of the system 10 without anomalies. This expectation can then be compared during operation, as described later with reference to FIG. 7, in order to conclude an anomaly from significant deviations. During teach-in, a system 10 free of anomalies is assumed, or any anomalies that are already present at this point in time cannot be uncovered later.

The procedure according to the invention is based on the assumption that the processes in the system 10 run periodically and consequently repeat after a specific period duration. This periodicity is then reflected accordingly in the measured values of the sensor 18. This assumption is regularly fulfilled in practice. For example, compressed air is used in the production of a particular component to handle the workpiece and to switch tools, starting the cycle over again with each subsequent component.

In a step S1, a time series of measured values of the sensor 18 for the respective flow velocity is collected in a buffer memory. This time series forms the input signal for the anomaly-free case to be taught in, and an example is shown in FIG. 3. The phase in which measured values are collected is selected to be sufficiently long so that the time series includes a plurality of cycles or periods of the process of the system 10 to be monitored.

In a step S2, the period duration of the time series is determined from the time series. Methods for determining the period duration of a time series are known per se and are based, for example, on an autocorrelation or Fourier transform. In order to reduce the complexity of the problem, the triggering of the time series can be reduced beforehand (“downsampling”).

In a step S3, the time series is subdivided into sections or periods of the period duration. FIG. 4 shows, individually one above the other, three of these periods of the time series according to FIG. 3, which, as visible to the naked eye, comprises a total of eight periods. The similarity across periods is clearly evident and already makes it plausible that significant deviations due to anomalies will be recordable.

In a step S4, a single period of the periods according to FIG. 4 is statistically evaluated. In a preferred embodiment, a histogram of the frequency of occurrence of the respective flow velocities or mass flows is formed for this purpose, as shown by way of example in FIG. 5 for one of the periods according to FIG. 4. For this purpose, the possible flow velocities or mass flows are subdivided into intervals or bins, preferably into uniform bins, and plotted on the X-axis, counting on the Y-axis for each bin how often an appropriate measured value was measured. Such a histogram is preferably generated repeatedly for at least some or preferably all periods of the time series. A histogram is a particularly suitable statistical tool, but other characteristic variables that can be used to describe the course of the measured values in a section as shown in FIG. 4 are also conceivable.

In a step S5, statistical measures, in particular a mean value and a standard deviation of the respective count, are calculated from the counts in the corresponding bins of the histograms at different periods. This results in an expectation of the distribution of flow velocities or mass flows together with a tolerance. The tolerance range can be defined by a corridor around the mean value at intervals of a plurality of, for example three, standard deviations up and down. FIG. 6 shows the resulting reference variables by small black dashes at the mean value of the bins along with the associated tolerance range highlighted in gray.

FIG. 7 shows an exemplary flow chart with which anomalies in the system 10 can be determined by comparing a time series of measured values recorded during operation to the taught-in reference variables and associated tolerances. The procedures according to FIGS. 2 and 7 are similar, because the respective time series of measured values from the operation are processed similarly to the teach-in process, in order to obtain characteristic variables that can be compared to the reference characteristic variables. In the procedure according to FIG. 2, however, reference characteristic variables are taught in when the system 10 is assumed to be free of anomalies, wherein the reference characteristic variables are not evaluated but stored as an expectation. Now in the procedure according to FIG. 7, characteristic variables with an unknown state of the system 10 are obtained and compared to the reference characteristic variables.

In a step S6, a time series of measured values of the sensor 18 for the respective flow velocity is collected in a buffer memory. This time series forms the input signal, and FIG. 8 shows an example. For this time series, in contrast to the one according to FIG. 3, whether or not there are anomalies in the system is not known in advance. The phase in which measured values for the time series are collected is selected to be sufficiently long to cover at least one period, preferably a plurality of periods, of the process of the system 10 to be monitored.

In a step S7, the period duration of the time series is determined from the time series. For the procedure, reference is made to step S2 according to FIG. 2, wherein in particular the identical method can be used. In all other respects, the period duration is known from the teach-in so that step S7 is optional. On the other hand, it may be useful to actually relate the period duration to the current time series in order to catch fluctuations, or also as a plausibility check, because a greater deviation between the period duration determined during teach-in and the period duration determined during operation indicates in itself an anomaly or at least a violation of the assumption of a stable periodic process in the system 10. If a different period duration is determined repeatedly and stably in itself in step S7 than during teach-in in step S2, this may also be due to the fact that the process in system 10 was changed over without teaching in reference characteristic variables again.

In a step S8, analogously to step S3, the time series is subdivided into sections or periods of the period duration. FIG. 9 shows three of these periods of the time series according to FIG. 8, individually one above the other. With the naked eye, it can already be assumed by comparison to FIG. 4 that an anomaly is present.

In a step S9, a single period according to FIG. 9 is statistically evaluated analogously to step S4. For this purpose, in a preferred embodiment, a histogram of the frequency of occurrence of the respective flow velocities or mass flows is formed, as shown by way of example in FIG. 10 for one of the periods according to FIG. 9. The histogram can be formed from one or more periods. If a plurality of periods is used, a normalization is preferably performed in order to be able to compare the characteristic variables obtained from the histogram, in particular the counts in the bins, to the reference variables. The method for detecting anomalies reacts somewhat more sluggishly when using a plurality of periods, with all the advantages and disadvantages in this regard. A histogram is a particularly suitable statistical tool, but other characteristic variables that can be used to describe the course of the measured values in a section as shown in FIG. 9 are also conceivable.

In a step S10, the characteristic variables obtained in step S9 are compared to the reference variables. Differences within the associated tolerances are still accepted; a stronger change is concluded to be an anomaly. FIG. 11 shows the result of a comparison of the histogram according to FIG. 10 from a period of current measured values to the expectations according to FIG. 6. The height of the bars shown corresponds to the measured characteristic variables according to FIG. 10, but the bars have different gray values depending on the comparison result. For the gray penultimate bar, the comparison was within the tolerance. The light-colored bars, on the other hand, resulted in a downward difference, and the black bars in an upward difference, each outside the tolerance. Consequently, the mean distribution of the measured values within the period or periods under consideration has changed so much in this example that an anomaly is assumed; otherwise, all bars should have indicated a position within the tolerance like the penultimate gray bar. In this case, an additional summary tolerance would be conceivable, which allows a significant deviation for one bin or a certain percentage of bins, without indicating an anomaly.

FIG. 12 shows a comparative illustration of a respective period according to FIG. 4 in a system 10 without an anomaly and according to FIG. 9 in a system 10 to be checked. Obviously, the described evaluation of the characteristic variables in comparison to the reference variables in the explained example comes to the correct conclusion because an anomaly is evidently present here.

The described detection of anomalies is based on an evaluation by means of histograms. The time series of one period or a plurality of periods can also be evaluated in other ways, such as box plots, bar charts or quantile-quantile plots. As a statistical measure, a median or other quantile can be used instead of the mean value, and fluctuations can also be reflected by quantiles or higher mo-ments instead of via the standard deviation. A further alternative is to select one IIR filter per bin of the histogram with low-pass characteristics and a suitable time constant in order to approximate the frequency of the measured values in the class. In this case, a new cycle of all IIR filters is executed when a new measured value occurs. The input value of the respective IIR filter is “0” if the measured value does not belong to its bin, and “1” otherwise.

In a further alternative, the evaluation can be based on a representative period. This representative period can be calculated by initially eliminating the phase shift for all periods so that the individual periods are as congruent to one another as possible. Subsequently, the mean value along with the standard deviation of the corresponding measured values can be formed for each point in time within a period. Based on the standard deviation, a tolerance can then be specified for each point in time. FIG. 13 illustrates a representative period within the measured values of the original periods. FIG. 14 shows a separate illustration of the representative period including the tolerance band defined via the standard deviation. The individual points form the reference characteristic variables, and during operation, a period is compared thereto, which period must lie everywhere or to a defined proportion within the tolerance band. The period determined during operation can also be formed as a representative period from a plurality of periods.

FIG. 15 again illustrates a further alternative based on determining the area between a taught-in period and a period recorded during operation for the detection of anomalies. Preferably, it is an area between representative periods. Mathematically, the area corresponds to the integral over the magnitude of the difference. The resulting area should remain small, for example measured as a proportion of the integral of one of the periods itself.

A respective teach-in of reference characteristic variables relates to a specific cyclic process in the system 10. Since industrial manufacturing processes are always changing, for example due to format changes, product modifications or product switches, it is important that the sensor 18 can respond by simply teaching in. Preferably, which product will be produced in the future is communicated to the sensor 18 so that the teach-in is triggered. The sensor 18 can also build up a database of reference characteristic variables on the various product variants and, in the case of a process that is already known, can simply switch over instead of relearning.

If the sensor 18 has no knowledge of the manufacturing process, the sensor 18 can also temporarily put itself into teach-in mode on its own and, after recording reference variables, transition to anomaly detection, or gradually build up a collection of reference variables. The self-determined period durations con-stitute the deciding characteristic as to whether a different process takes place. Thus, if the period duration is already known, the sensor 18 can fall back on pre-viously determined reference variables, or otherwise teach in the required reference variables automatically.

In an extension of the described procedure, not only is it determined that an anomaly exists, but anomalies are also distinguished. For this purpose, corre-spondingly finer differentiating reference characteristic variables have to be taught in. Knowing the structure of the system 10, for example through circuit diagrams, switching signals or functional diagrams, it is also possible to localize detected anomalies.

1. A sensor device for detecting an anomaly in a fluid power system, comprising at least one sensor for determining a measured value for the instantaneous flow velocity in a line of the system, and a control and evaluation unit configured to determine, on the basis of at least one measured value, whether an anomaly is present, wherein the control and evaluation unit is further configured to evaluate a time series of measured values in order to initially determine a period duration, to determine at least one characteristic variable for at least one section of the time series of the period duration, to compare the characteristic variable to a reference characteristic variable and, in the event of deviation by more than a tolerance, to determine the presence of an anomaly.

2. The sensor device according to claim 1,
wherein the control and evaluation unit is configured to determine a statistical characteristic variable of the distribution of flow velocities over the period duration.

3. The sensor device according to claim 1,
wherein the control and evaluation unit is configured to form a histogram of the flow velocities over the period duration, wherein at least one characteristic variable is determined from the count in one bin of the histogram.

4. The sensor device according to claim 1,
wherein the control and evaluation unit is configured to determine the cumulative difference between the measured values of the time series and a reference time series.

5. The sensor device according to claim 1,
wherein the control and evaluation unit is configured to record and evaluate the time series of measured values during operation of the system.

6. The sensor device according to claim 1,
wherein the control and evaluation unit is configured to determine the period duration by calculating an autocorrelation, Fourier transform or magnitude differences of the time series.

7. The sensor device according to claim 1,
wherein the control and evaluation unit is configured to detect and correct a mutual time offset of sections of the period duration.

8. The sensor device according to claim 1,
wherein the control and evaluation unit is configured to convert the time series of measured values into a time series with lower temporal resolution.

9. The sensor device according to claim 1,
wherein the control and evaluation unit is configured for a teach-in mode in which a time series of measured values is recorded and evaluated, a period duration is determined therefrom, at least one characteristic variable is determined for at least one section of the time series of the period duration and the characteristic variable is stored as a reference characteristic variable.

10. The sensor device according to claim 9,
wherein, in teach-in mode, a respective characteristic variable is determined several times over different sections, in order to determine a statistical measure as a reference characteristic variable and/or a fluctuation measure as a tolerance of the stored reference characteristic variable.

11. The sensor device according to claim 9,
wherein, in teach-in mode, a histogram of the flow velocities over the period duration is formed, wherein the reference characteristic variable is determined from a count in a bin of the histogram and/or the associated tolerance is determined from a fluctuation measure of the count in a bin.

12. The sensor device according to claim 9,
wherein the control and evaluation unit is configured to switch temporarily to teach-in mode when the period duration changes.

13. The sensor device according to claim 1,
wherein the control and evaluation unit is configured to switch between a plurality of sets of at least one reference variable.

14. The sensor device according to claim 1,
wherein the control and evaluation unit is integrated in the sensor.

15. A method for detecting an anomaly in a fluid power system, wherein at least one sensor determines a respective measured value for the instantaneous flow velocity in a line of the system and it is determined, on the basis of at least one measured value, whether an anomaly is present,
wherein a time series of measured values is evaluated in order to initially determine a period duration, at least one characteristic variable is determined for at least one section of the time series of the period duration, the characteristic variable is compared to a reference characteristic variable and, in the event of deviation by more than one tolerance, the presence of an anomaly is determined.
